(19) United States
(12) Patent Application Publication
(10) Pub. No.: US 2026/0012052 A1
(43) Pub. Date: Jan. 8, 2026

(54) OUTER ROTOR STRUCTURE FOR A MOTOR, ROTARY POWER UNIT, AND QUADRUPED ROBOT

(71) Applicant: HangZhou YuShu TECHNOLOGY CO.,LTD., Hangzhou, Zhejiang (CN)

(72) Inventor: Xingxing WANG, Hangzhou, Zhejiang (CN)

(21) Appl. No.: 18/877,918

(22) PCT Filed: Dec. 14, 2022
(86) PCT No.: PCT/CN2022/139081

§ 371 Date: Dec. 20, 2024

(30) Foreign Application Priority Data
Jun. 23, 2022 (CN) 202221590221.5

(51) Int. Cl. H02K 1/30; H02K 1/2791

(52) U.S. Cl. CPC H02K 1/30; H02K 1/2791

(57) ABSTRACT

An outer rotor structure for a motor, rotary power unit, and quadruped robot. The outer rotor structure includes: a magnetic steel sleeve, where an edge of the magnetic steel sleeve extends toward an axis of the magnetic steel sleeve to form a flange; and a rotor end cover provided with a step fitting with the flange on the edge thereof. The rotor end cover is nested in the magnetic steel sleeve. The flange presses against the step to unidirectionally fix the rotor end cover relative to the magnetic steel sleeve in an axis direction. The rotor end cover is nested in the magnetic steel sleeve and the flange of the magnetic steel sleeve presses against the step of the rotor end cover to axially fix the rotor end cover to the magnetic steel sleeve. When a motor unit is subjected to an impact transmitted from a speed reduction unit, the rotor end cover does not disengage from the magnetic steel sleeve.

### TECHNICAL FIELD

The utility model relates to the technical field of outer rotor motors, and in particular to an outer rotor structure for a motor, a rotary power unit, and a quadruped robot.

### BACKGROUND

A rotary power unit is one of the core components of a quadruped robot, and includes a motor unit and a speed reduction unit. Most of the existing motor units adopt outer rotor motors. For example, the Chinese patent CN211693390 provides an electrically driven rotary power unit, where the motor includes a stator and an outer rotor; the stator is fixed on an upper end cover, and a support end face on a side of the outer rotor is located away from an output end cover relative to the stator; alternatively, the stator is fixed on a lower end cover, and the support end face on the side of the outer rotor is located close to the output end cover relative to the stator; and the outer rotor is rotatably connected to the stator by means of a connector and a bearing.

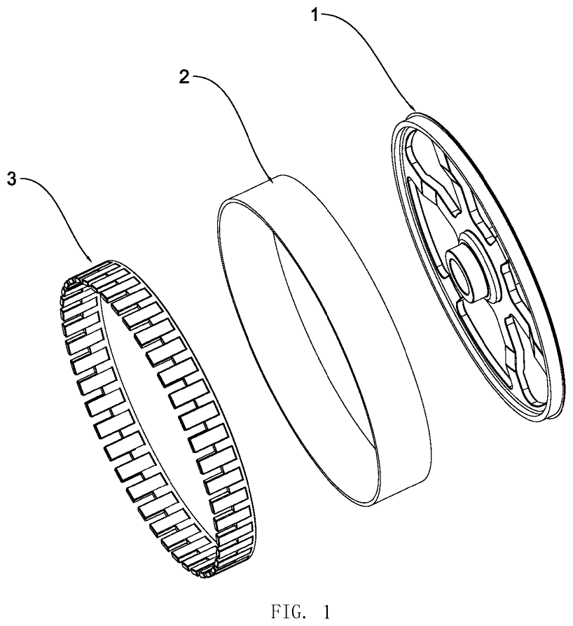

In the above technical solution, the motor unit adopts an outer rotor motor. The specific structure of the outer rotor is as shown in FIG. 1, including an end cover 1, a steel sleeve 2, and a magnetic steel assembly 3, where the edge of the end cover 1 extends radially to form a flange abutting on an end face of the steel sleeve 2, and the end cover 1 is superposed and partially snap-fit with the steel sleeve 2 for fixation.

### SUMMARY

### Technical Problems

However, the quadruped robot may inevitably fall during use, or a hip joint thereof may undergo a sudden external impact, the direction of the instantaneous impact is unfixed. When the direction of the instantaneous impact is from the magnetic steel assembly 3 to the end cover 1, the end cover 1 and the steel sleeve 2 connected by superposition may loosen or disengage from each other, resulting in faults of the outer rotor and the quadruped robot and failure in normal use, thereby affecting the service life of the robot, which is not conducive to popularization.

### Solutions of the Problems

### Technical Solutions

In order to overcome the defects of the prior art, the first objective of the utility model is to provide an outer rotor structure for a motor, where a magnetic steel sleeve and a rotor end cover do not disengage from each other when subjected to an axial impact.

The second objective of the utility model is to provide an outer rotor structure for a motor, where a rotor end cover is nested in a magnetic steel sleeve, and a retaining portion of the magnetic steel sleeve presses against an edge of the rotor end cover to axially limit the rotor end cover to the magnetic steel sleeve. The solution is simple, practical, and feasible.

The third objective of the utility model is to provide an outer rotor structure for a motor, where by means of the nesting of a rotor end cover in a magnetic steel sleeve and the limiting of a retaining portion, the rotor end cover may be effectively prevented from loosening or disengaging when the direction of an instantaneous impact is from the magnetic steel assembly to the rotor end cover, ensuring normal use of the outer rotor and the quadruped robot in various extreme conditions, and thereby effectively improving the service life of the robot, which is conducive to popularization.

The fourth objective of the utility model is to provide a rotary power unit including an outer rotor structure for a motor, where a magnetic steel sleeve and a rotor end cover do not disengage from each other when subjected to an axial impact.

The fifth objective of the utility model is to provide a quadruped robot including an outer rotor structure for a motor, where a magnetic steel sleeve and a rotor end cover do not disengage from each other when subjected to an axial impact.

In order to achieve one of the above objectives, the first technical solution of the utility model is as follows:

An outer rotor structure for a motor includes: a magnetic steel sleeve, where an edge of the magnetic steel sleeve extends toward an axis of the magnetic steel sleeve to form a retaining portion; and a rotor end cover, where the rotor end cover is nested in the magnetic steel sleeve, and the retaining portion presses against an edge of the rotor end cover to unidirectionally fix the rotor end cover relative to the magnetic steel sleeve in an axis direction.

As a preferable technical solution, the retaining portion is a flange formed by directly bending the edge of the magnetic steel sleeve, which facilitates production and results in low production costs.

As a preferable technical solution, a step fitting with the flange is provided on the edge of the rotor end cover, and the flange presses against the step to unidirectionally fix the rotor end cover relative to the magnetic steel sleeve in the axis direction. The step is provided on the edge of the rotor end cover to make the fitting of the rotor end cover with the magnetic steel sleeve more compact, resulting in a smaller volume.

As a preferable technical solution, a magnetic steel assembly is fixed in the magnetic steel sleeve, and the magnetic steel assembly includes a magnetic steel fixing member and magnetic steel uniformly fixed on the magnetic steel fixing member.

In order to achieve one of the above objectives, the second technical solution of the utility model is as follows:

An outer rotor structure for a motor includes:
a magnetic steel sleeve with an accommodation space and a rotor end cover of an arcuate structure.

The magnetic steel sleeve is provided with a retaining portion for limiting the range of a movement of the rotor end cover.

The rotor end cover is nested in the accommodation space of the magnetic steel sleeve, and the retaining portion presses against an edge of the rotor end cover to limit the rotor end cover relative to the magnetic steel sleeve in an axis direction.

In the utility model, upon continuous exploration and experimentation, the rotor end cover is nested in the magnetic steel sleeve, and the retaining portion of the magnetic steel sleeve presses against the edge of the rotor end cover to axially limit the rotor end cover to the magnetic steel sleeve. The solution is simple, practical, and feasible.

Furthermore, in the utility model, by means of the nesting of the rotor end cover in the magnetic steel sleeve and the limiting of the retaining portion, the rotor end cover may be effectively prevented from loosening or disengaging when the direction of the instantaneous impact is from the magnetic steel assembly to the rotor end cover, ensuring normal use of the outer rotor and the quadruped robot in various extreme conditions, and thereby effectively improving the service life of the robot, which is conducive to popularization.

As a preferable technical solution,
the retaining portion is provided along an edge of the magnetic steel sleeve and extends toward the accommodation space of the magnetic steel sleeve to vary an opening space of the accommodation space, so as to adapt to various limiting requirements.

As a preferable technical solution,
the retaining portion is an annular structure provided around the magnetic steel sleeve, so that the retaining portion can provide a uniform resisting force when a rotor terminal is subjected to an impact force.

Alternatively, the retaining portion is a sheet structure arranged at intervals. The rotor end cover is limited through only the sheet structure, to reduce the weight of the magnetic steel sleeve while the structural strength is satisfied, thereby avoiding overweight of the quadruped robot.

Alternatively, the retaining portion is a pin structure capable of insertion into the magnetic steel sleeve, so as to facilitate detachment.

As a preferable technical solution,
a step fitting with the retaining portion is provided on the periphery of the rotor end cover, and the retaining portion presses against the step, so that the rotor end cover and the magnetic steel sleeve are subjected to uniform forces.

Alternatively, a notch and a slit that fit with the sheet structure are provided on the edge of the rotor end cover.

The notch is in communication with the slit to allow the sheet structure to be screwed into the slit from the notch, so that the rotor end cover and the magnetic steel sleeve are reliably fixed together.

Alternatively, an insertion hole fitting with the pin structure is provided on the edge of the rotor end cover, so that the rotor end cover and the magnetic steel sleeve are reliably fixed together.

In order to achieve one of the above objectives, the third technical solution of the utility model is as follows:

A rotary power unit includes the outer rotor structure for a motor as described above.

In order to achieve one of the above objectives, the fourth technical solution of the utility model is as follows:

A quadruped robot includes the outer rotor structure for a motor as described above.

### Beneficial Effects of the Utility Model

### Beneficial Effects

In the outer rotor structure for a motor provided by the utility model, the rotor end cover is nested in the magnetic steel sleeve, and the retaining portion of the magnetic steel sleeve presses against the edge of the rotor end cover to axially fix the rotor end cover to the magnetic steel sleeve, so that when the motor unit is subjected to an impact transmitted from the speed reduction unit, the rotor end cover does not disengage from the magnetic steel sleeve.

Furthermore, in the utility model, by means of the nesting of the rotor end cover in the magnetic steel sleeve and the limiting of the retaining portion, the rotor end cover may be effectively prevented from loosening or disengaging when the direction of the instantaneous impact is from the magnetic steel assembly to the rotor end cover, ensuring normal use of the outer rotor and the quadruped robot in various extreme conditions, and thereby effectively improving the service life of the robot, which is conducive to popularization.

In the rotary power unit including an outer rotor structure for a motor provided by the utility model, the rotor end cover is nested in the magnetic steel sleeve, and the retaining portion of the magnetic steel sleeve presses against the edge of the rotor end cover to axially fix the rotor end cover to the magnetic steel sleeve, so that when the motor unit is subjected to an impact transmitted from the speed reduction unit, the rotor end cover does not disengage from the magnetic steel sleeve, thereby improving the operation stability of the rotary power unit.

In the quadruped robot including an outer rotor structure for a motor provided by the utility model, the rotor end cover is nested in the magnetic steel sleeve, and the retaining portion of the magnetic steel sleeve presses against the edge of the rotor end cover to axially fix the rotor end cover to the magnetic steel sleeve, so that when the motor unit is subjected to an impact transmitted from the speed reduction unit, the rotor end cover does not disengage from the magnetic steel sleeve, thereby improving the operation stability of the quadruped robot.

### BRIEF DESCRIPTION OF THE DRAWINGS

### Description of the Drawings

FIG. 1 is a schematic diagram of a structure of an outer rotor for a motor in the prior art;

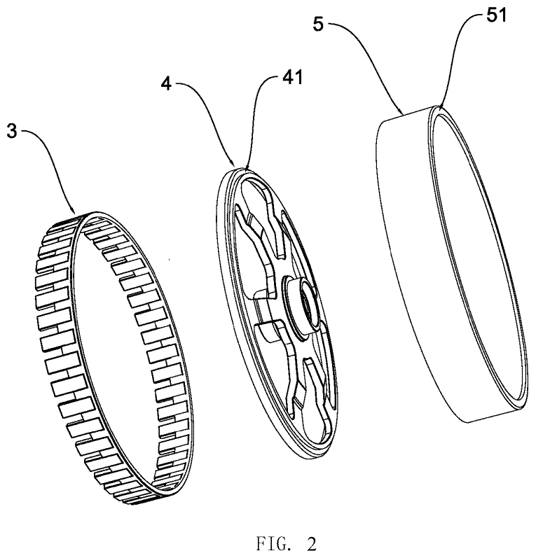

FIG. 2 is an exploded view of an outer rotor structure for a motor according to the utility model;

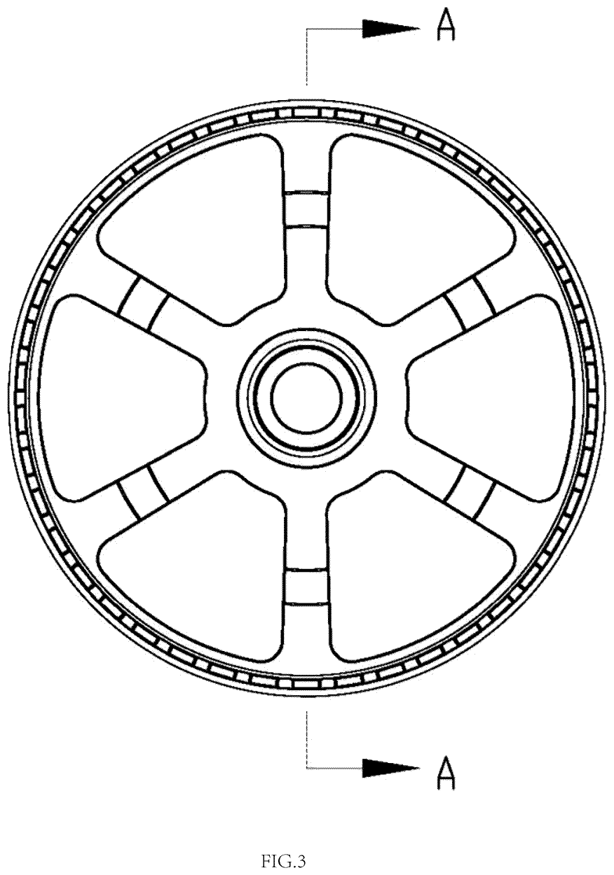

FIG. 3 is a schematic diagram of a structure of an outer rotor structure for a motor according to the utility model; and

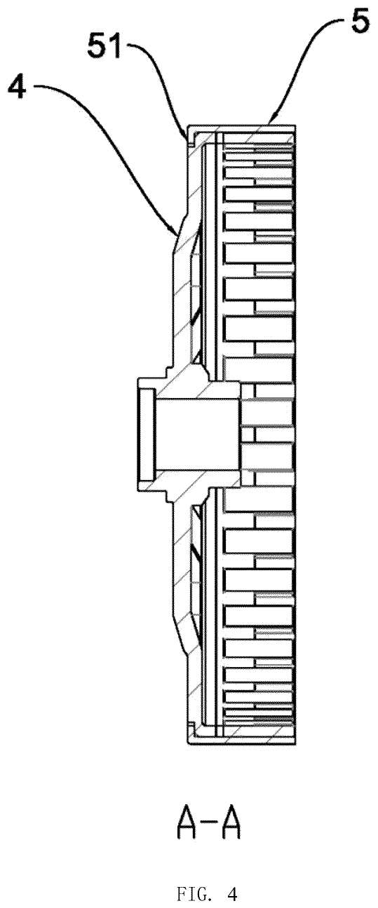

FIG. 4 is a sectional view of the structure shown in FIG. 3 in the A-A direction.

### LIST OF REFERENCE SIGNS

1. end cover; 2. steel sleeve; 3. magnetic steel assembly; 4. rotor end cover; 41. step; 5. magnetic steel sleeve; and 51. flange.

### DETAILED DESCRIPTION OF THE EMBODIMENTS

### Implementations of the Utility Model

The utility model is further described below in conjunction with the accompanying drawings and specific embodiments. It should be noted that, in case of no conflicts, the embodiments or technical features described below may be combined to form new embodiments.

Unless otherwise defined, all technical and scientific terms used in the utility model have the same meanings as those commonly understood by those skilled in the art to which the utility model relates. The terms used in the utility model are only for the purpose of describing specific embodiments, and are not intended to limit the utility model.

As shown in FIGS. 2, 3, and 4, the first specific embodiment an outer rotor structure for a motor according to the utility model is as follows:

An outer rotor structure for a motor includes: a magnetic steel sleeve 5, where an edge of the magnetic steel sleeve 5 extends toward an axis of the magnetic steel sleeve to form a retaining portion; and a rotor end cover 4, where the rotor end cover 4 is nested in the magnetic steel sleeve 5, and the retaining portion presses against an edge of the rotor end cover 4 to unidirectionally fix the rotor end cover 4 relative to the magnetic steel sleeve 5 in an axis direction.

The second specific embodiment of an outer rotor structure for a motor according to the utility model is as follows:

An outer rotor structure for a motor includes a magnetic steel sleeve 5 with an accommodation space and a rotor end cover 4 of an arcuate structure.

The magnetic steel sleeve 5 is provided with a retaining portion for limiting the range of a movement of the rotor end cover 4.

The rotor end cover 4 has an outer diameter less than an inner diameter of the magnetic steel sleeve 5, and the rotor end cover 4 has a width less than a width of the magnetic steel sleeve 5, so that the rotor end cover 4 is nested in the accommodation space of the magnetic steel sleeve 5, and the retaining portion presses against an edge of the rotor end cover 4 to limit the rotor end cover 4 relative to the magnetic steel sleeve 5 in an axis direction.

The first specific embodiment of a limiting structure according to the utility model is as follows:

The retaining portion is a flange 51 formed by directly bending the edge of the magnetic steel sleeve 5, which facilitates production and results in low production costs. A step 41 fitting with the flange 51 is provided on the edge of the rotor end cover 4, and the flange 51 presses against the step 41 to unidirectionally fix the rotor end cover 4 relative to the magnetic steel sleeve 5 in the axis direction. The step 41 is provided on the edge of the rotor end cover 4 to make the fitting of the rotor end cover 4 with the magnetic steel sleeve 5 more compact, resulting in a smaller volume.

The retaining portion is an annular structure provided along an edge of the magnetic steel sleeve 5 and extends toward the accommodation space of the magnetic steel sleeve 5 to vary an opening space of the accommodation space, so as to adapt to various limiting requirements.

The second specific embodiment of a limiting structure according to the utility model is as follows:

The retaining portion is a sheet structure arranged at intervals. The rotor end cover 4 is limited through only the sheet structure, to reduce the weight of the magnetic steel sleeve 5 while the structural strength is satisfied, thereby avoiding overweight of the quadruped robot.

A step 41 fitting with the sheet structure is provided on the periphery of the rotor end cover 4, and the retaining portion presses against the step 41, so that the fitting of the rotor end cover 4 with the magnetic steel sleeve 5 is more compact.

The third specific embodiment of a limiting structure according to the utility model is as follows:

The retaining portion is a sheet structure arranged at intervals. A notch and a slit that fit with the sheet structure are provided on the edge of the rotor end cover 4. The notch is in communication with the slit to allow the sheet structure to be screwed into the slit from the notch, so that the rotor end cover 4 and the magnetic steel sleeve 5 are reliably fixed together.

The fourth specific embodiment of a limiting structure according to the utility model is as follows:

The retaining portion is a pin structure capable of insertion into the magnetic steel sleeve 5, so as to facilitate detachment.

An insertion hole fitting with the pin structure is provided on the edge of the rotor end cover 4, so that the rotor end cover 4 and the magnetic steel sleeve 5 are reliably fixed together.

A specific embodiment of a magnetic steel assembly 3 is further provided in the utility model:

The magnetic steel assembly 3 is fixed in the magnetic steel sleeve 5, and the magnetic steel assembly 3 includes a magnetic steel fixing member and magnetic steel uniformly fixed on the magnetic steel fixing member.

A specific embodiment of a rotary power unit according to the utility model is as follows:

The rotary power unit includes the outer rotor structure for a motor as described above.

A specific embodiment of a quadruped robot according to the utility model is as follows:

The quadruped robot includes the outer rotor structure for a motor as described above.

The above embodiments are merely preferred embodiments of the utility model, and the scope of protection of the utility model is not limited thereto. Any non-substantive changes or substitutions made by those skilled in the art on the basis of the utility model shall fall within the scope of protection claimed by the utility model.

1. An outer rotor structure for a motor, comprising:
a magnetic steel sleeve, wherein an edge of the magnetic steel sleeve extends toward an axis of the magnetic steel sleeve to form a retaining portion; and
a rotor end cover, wherein
the rotor end cover is nested in the magnetic steel sleeve, and the retaining portion presses against an edge of the rotor end cover to unidirectionally fix the rotor end cover relative to the magnetic steel sleeve in an axis direction.

2. The outer rotor structure for a motor according to claim 1, wherein
the retaining portion is a flange formed by directly bending the edge of the magnetic steel sleeve.

3. The outer rotor structure for a motor according to claim 2, wherein
a step fitting with the flange is provided on the edge of the rotor end cover, and the flange presses against the step to unidirectionally fix the rotor end cover relative to the magnetic steel sleeve in the axis direction.

4. The outer rotor structure for a motor according to claim 3, wherein a magnetic steel assembly is fixed in the magnetic steel sleeve, and the magnetic steel assembly comprises a magnetic steel fixing member and magnetic steel uniformly fixed on the magnetic steel fixing member.

5. An outer rotor structure for a motor,
comprising: a magnetic steel sleeve with an accommodation space and a rotor end cover of an arcuate structure, wherein
the magnetic steel sleeve is provided with a retaining portion for limiting the range of a movement of the rotor end cover; and
the rotor end cover is nested in the accommodation space of the magnetic steel sleeve, and the retaining portion presses against an edge of the rotor end cover to limit the rotor end cover relative to the magnetic steel sleeve in an axis direction.

6. The outer rotor structure for a motor according to claim 5, wherein
the retaining portion is provided along an edge of the magnetic steel sleeve and extends toward the accommodation space of the magnetic steel sleeve to vary an opening space of the accommodation space.

7. The outer rotor structure for a motor according to claim 6, wherein
the retaining portion is an annular structure provided around the magnetic steel sleeve;
the retaining portion is a sheet structure arranged at intervals; or
the retaining portion is a pin structure capable of insertion into the magnetic steel sleeve.

8. The outer rotor structure for a motor according to claim 7, wherein
a step fitting with the retaining portion is provided on the periphery of the rotor end cover, and the retaining portion presses against the step;
a notch and a slit that fit with the sheet structure are provided on the edge of the rotor end cover,
and the notch is in communication with the slit to allow the sheet structure to be screwed into the slit from the notch; or
an insertion hole fitting with the pin structure is provided on the edge of the rotor end cover.

9. A rotary power unit, comprising the outer rotor structure for a motor according to claim 1.

10. (canceled)

11. A rotary power unit, comprising the outer rotor structure for a motor according to claim 5.

12. A quadruped robot, comprising the outer rotor structure for a motor according to claim 1.

13. A quadruped robot, comprising the outer rotor structure for a motor according to claim 5.

14. A quadruped robot, comprising the rotary power unit according to claim 9.

15. A quadruped robot, comprising the rotary power unit according to claim 11.
